(19) United States
(12) Patent Application Publication
(10) Pub. No.: US 2017/0080744 A1
(43) Pub. Date: Mar. 23, 2017

(54) Protective Mat

(71) Applicant: Anamarie Seidel, Olympia, WA (US)

(72) Inventor: Anamarie Seidel, Olympia, WA (US)

(21) Appl. No.: 14/857,791

(22) Filed: Sep. 17, 2015

(51) Int. Cl. B44B 11/00

(52) U.S. Cl. CPC B44B 11/00; B44B 2700/12

(57) ABSTRACT

A protective mat is provided which may protect surfaces such as a table top from contact, penetration, or damage from objects or substances such as nail polish and acetone. A protective mat may have raised edge around the periphery to keep spilled liquid from flowing out the mat. A protective mat may contain shapes with raised ridges and recessed middle to act as a well for example in mixing various colors. A protective mat may contain other various shapes for the user to try out various nail art decals or use as a palette for example. A protective mat may contain a ruler and grid to assist a user in designing a nail art decal for example.

### FIELD

This disclosure relates generally to a protective mat.

### BACKGROUND

A typical mat for crafts is primarily used to protect surfaces from polish, glue, acetone and various other materials. Existing mats have flat surfaces. While a flat surface may offer protection from viscous liquid or small volume spills, it may not be enough protection for less viscous liquids or large spills like spilling a bottle of nail polish remover.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a protective mat. A protective mat may be used in various contexts including but not limited to nail art applications, like stamping embossing, painting, beading, jewelry-making, or stamping for example. It may protect surfaces, such as a table, from objects or spills of liquids such as nail polish or nail polish remover by having a raised border. The raised border may also prevent the loss of small pieces, such as beads, by preventing them from rolling off of the protective mat. The protective mat may be approximately 12″ by 16″ in size, and 1 mm to 3 mm thick. The protective mat may be used as a surface for applications such as nail art or decals. The protective mat may have embossed areas to be used as color wells to mix various nail polish colors or solutions for example. The protective mat may be made of latex, silicone or other material. The protective mat may be made from heat resistant material which may provide surfaces with protection from high temperatures. For example, when embossing one may use a heat source like a hair dryer or glue gun. In addition, a user may use the protective mat for baking polymer clay, for example. The protective mat may also have a raised border to help prevent spills from leaving the mat. The protective mat may also have a ruler to allow users to make decals that fit their nails, minimizing trimming. The protective mat may have shapes drawn on the mat to help users test their nail art or use as a palette. The protective mat may have a backing material that is smooth, or that prevents the mat from slipping. The work surface of the protective mat may be made of non-stick material so the materials used in nail art or other craft such as nail polish or adhesives may not stick and may be wiped off easily. The protective mat may be made of flexible material that allows the mat to be rolled up for easy storage and travel for example. In addition, the protective mat may be reusable, dishwasher safe and adhesive resistant helping make clean up easy. A person skilled in the art will understand that a protective mat may comprise various colors and other functional and aesthetic characteristics.

Many of the attendant features may be more readily appreciated as they become better understood by reference to the following detailed description considered in connection with the attached drawings.

### BRIEF DESCRIPTION OF THE DRAWINGS

FIG. 1 illustrates a top view of a protective mat, according to one embodiment.

FIG. 2 illustrates a side view of the side of a protective mat, according to one embodiment.

FIG. 3 illustrates a top view of a protective mat, according to one embodiment.

Like reference numerals are used to designate like parts in the accompanying drawings.

### DETAILED DESCRIPTION

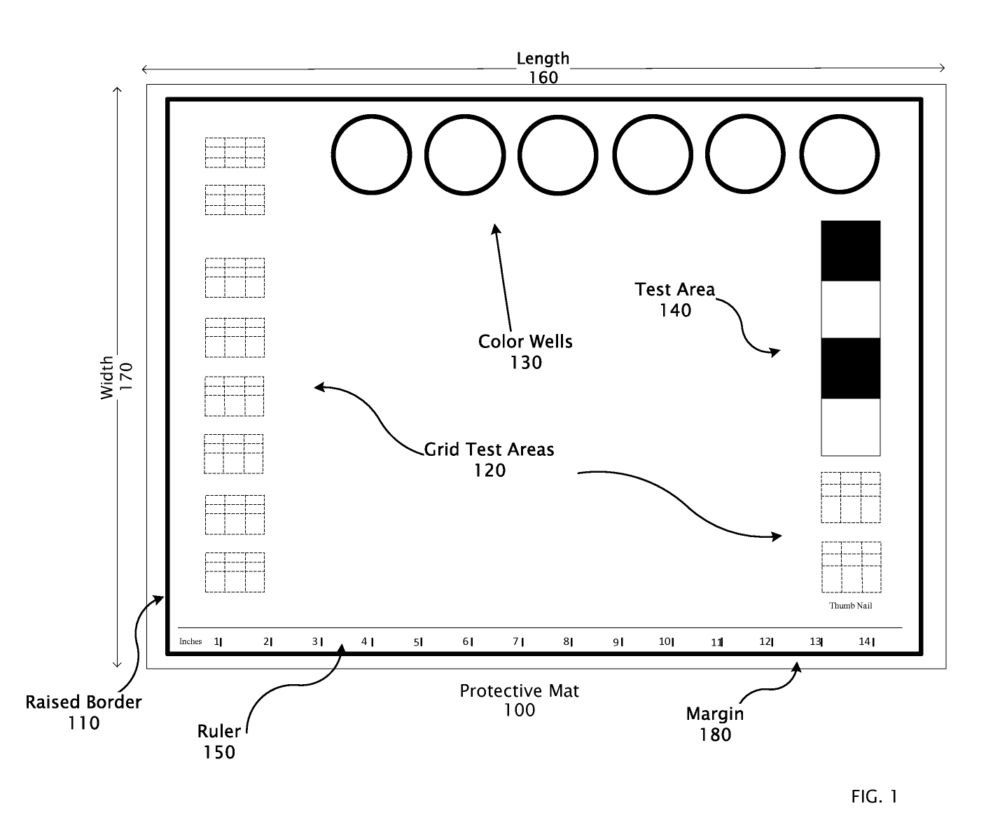

FIG. 1 illustrates Protective Mat 100 according to one embodiment. In this embodiment, Protective Mat 100 may include Raised Border 110, Grid Test Areas 120, Color Wells 130, Test Area 140, and Ruler 150. Raised Border 110 may be on outside edges of Protective Mat 100, or may be offset from outside edges by Margin 180, which may be approximately ½ inch, for example. Raised Border 110 may allow Protective Mat 100 to retain liquid in the event of a spill. Raised Border 110 may also contain small parts, such as beads. Protective Mat 100 may be used, for example, for beads, glitter, rhinestones, charms, paint, or polish.

Grid Test Areas 120 may be composed of different shapes or sizes of grids. This may allow a user to test various nail designs according to certain sizes or measurements to allow a transfer to nails without much trimming, for example. The flat surface of Test Area 140 may be square or other shapes that would allow a user to test out polish layering and or decal combinations, or serve as a palette for example.

Color Wells 130 may be circular shapes with a raised border and a recessed middle area, for example, which may allow users to mix various kinds of water colors or other liquids without the liquid spilling over the mat.

Protective Mat 100 may have a Ruler 150 which may allow a user to make specific-sized decals minimizing trimmings, measuring polymer clay, or jewelry components, for example. Ruler 150 may show American measurements or metric measurements, for example. In another embodiment, Protective Mat 100 may have a first ruler showing American measurements and a second ruler showing metric measurements.

Protective Mat 100 may roll up for easy storage or travel.

Protective Mat may have Length 160, which may be approximately 16 inches, and Width 170 of approximately 12 inches. In another embodiment, Protective Mat 100 may be larger or smaller.

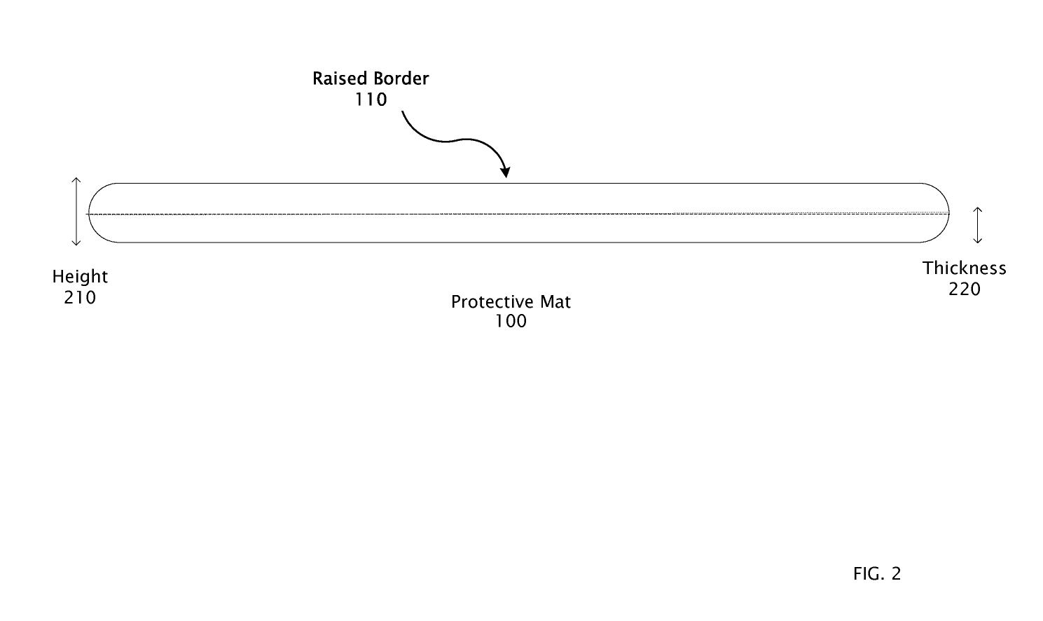

FIG. 2 illustrates an edge view of Protective Mat 100, according to one embodiment. Protective Mat 100 may have Thickness 220 of approximately 1 mm to 3 mm, and overall Height 210 with Raised Border 110 of approximately 1 mm to 3 mm. In another embodiment, Protective Mat 100 may be thicker or thinner, and Raised Border 110 may be higher or lower.

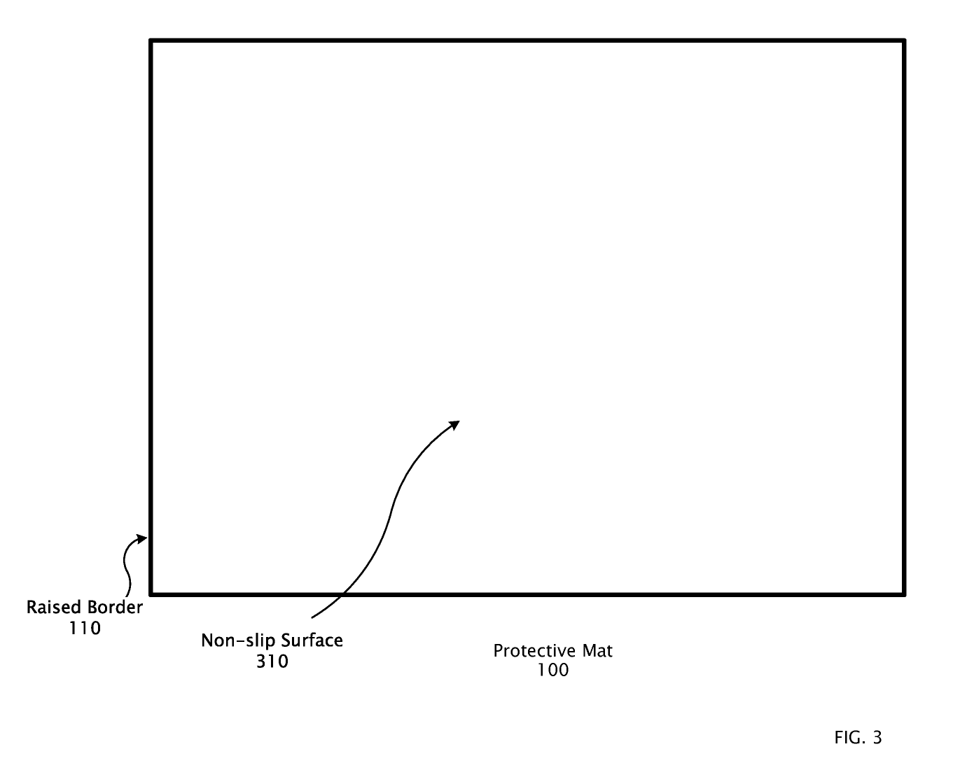

FIG. 3 illustrates a bottom view of Protective Mat 100, according to one embodiment. Non-slip Surface 310 may help prevent Protective Mat 100 from moving during use. Non-slip Surface 310 may be rubber or any other material which may help prevent slipping on a table or other work surface Protective Mat 100 may be used on. Non-slip Surface 310 may be incorporated into Protective Mat 100, or may be attached to Protective Mat 100 through the use of adhesives, mechanical connectors, or other means. Non-slip Surface 310 may also be, for example, suction cups integrated into Protective Mat 100. Protective Mat 100 may also have a smooth bottom surface.

A person skilled in the art will understand that a protective mat may have various colors and other functional and aesthetic characteristics. A protective mat may be used in various contexts including but not limited to nail art applications, costume and makeup applications, medical procedures, athletic and recreational activities, and arts and crafts such as painting, woodwork, glasswork, and ceramics, for example.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A mat, comprising:
a non-stick upper-side;
a raised border between one and five mm high; and
at least one well, the well having a raised perimeter between one and five mm high.

2. The mat of claim 1 further comprising a ruler.

3. The mat of claim 1 wherein the mat is made of silicone.

4. The mat of claim 1 wherein the mat is 11 to 13 inches wide.

5. The mat of claim 1 wherein the mat is 15 to 17 inches long.

6. The mat of claim 1 wherein the mat is 1 to 3 mm thick.

7. The mat of claim 1 wherein the well is circular.

8. The mat of claim 1 further comprising markings to indicate test areas.

9. The mat of claim 8 wherein the markings comprise grids.
